(19) United States
(12) Patent Application Publication
(10) Pub. No.: US 2026/0168672 A1
(43) Pub. Date: Jun. 18, 2026

(54) FLAMEHOLDER FOR A REHEAT ASSEMBLY OF A GAS TURBINE ENGINE

(71) Applicant: ROLLS-ROYCE plc, London (GB)

(72) Inventors: Ashley J. POWELL, Derby (GB); Andrew WILKINSON, Derby (GB); Eduardo ROMERO, Derby (GB); Thomas GWILLIAM, Derby (GB)

(73) Assignee: ROLLS-ROYCE plc, London (GB)

(21) Appl. No.: 19/395,519

(22) Filed: Nov. 20, 2025

(30) Foreign Application Priority Data
Dec. 12, 2024 (GB) 2418197.6

(51) Int. Cl. F23R 3/18; F02K 3/10

(52) U.S. Cl. CPC F23R 3/18; F02K 3/10; F05D 2220/323; F05D 2240/35

(57) ABSTRACT

A flameholder for a reheat assembly of a gas turbine engine. The flameholder includes a main structure and a baffle structure. The baffle structure is suspended within the main structure at one or more mounting locations. The baffle structure is coextensive with the main structure along a coextensive extent. The baffle structure has a detached portion spaced apart from the one or more mounting locations.

This specification is based upon and claims the benefit of priority from United Kingdom Patent Application No. 2418197.6, filed on 12 Dec. 2024, the entire contents of which are incorporated herein by reference.

### CROSS REFERENCE TO RELATED APPLICATIONS

This represents the first application directed towards the subject-matter.

### FIELD

This disclosure relates to a flameholder for a reheat assembly of a gas turbine engine. This disclosure further relates to a reheat assembly comprising such a flameholder, a gas turbine engine comprising such a reheat assembly, and an aircraft comprising such a gas turbine engine.

### BACKGROUND

Conventionally, a reheat assembly may be provided to a gas turbine engine for the purpose of providing increased thrust. A reheat assembly increases thrust by injecting fuel into a flow of air which has been exhausted from a core of the gas turbine engine. The fuel is dispersed within the flow of air and mixes with the flow of air to form a fuel-air mixture within the flow of air prior to being entrained into a wake of a flameholder. Within the wake of the flameholder, the fuel-air mixture is combusted in a flame. The heat released by the flame reheats the flow of air from the core of the gas turbine engine and provides the required additional thrust. Radiative heat released by the flame also results in heating of nearby upstream components, including the flameholder.

### SUMMARY

According to a first aspect there is provided a flameholder for a reheat assembly of a gas turbine engine, wherein:
the flameholder comprises a main structure and a baffle structure;
the main structure at least partially defines a flow direction for flow through the flameholder;
the baffle structure is suspended within the main structure at one or more mounting locations;
the baffle structure is coextensive with the main structure in the flow direction along a coextensive extent; and
the baffle structure has a detached portion spaced apart from the one or more mounting locations, the detached portion being detached from the main structure over a continuous extent.

In an embodiment, the continuous extent is at least 10 percent of the coextensive extent. In an embodiment, the continuous extent is at least 15 percent of the coextensive extent. In an embodiment, the continuous extent is at least 20 percent of the coextensive extent. In an embodiment, the continuous extent is at least 25 percent of the coextensive extent. In an embodiment, the continuous extent is at least 30 percent of the coextensive extent. In an embodiment, the continuous extent is at least 35 percent of the coextensive extent. In an embodiment, the continuous extent is no greater than 90 percent of the coextensive extent. In an embodiment, the continuous extent is no greater than 80 percent of the coextensive extent.

In an embodiment, the continuous extent is: between 10 and 99 percent, between 10 and 95 percent, between 10 and 90 percent, or between 10 and 80 percent of the coextensive extent. In an embodiment, the continuous extent is: between 15 and 99 percent, between 15 and 95 percent, between 15 and 90 percent, or between 15 and 80 percent of the coextensive extent. In an embodiment, the continuous extent is: between 20 and 99 percent, between 20 and 95 percent, between 20 and 90 percent, or between 20 and 80 percent of the coextensive extent. In an embodiment, the continuous extent is: between 25 and 99 percent, between 25 and 95 percent, between 25 and 90 percent, or between 25 and 80 percent of the coextensive extent. In an embodiment, the continuous extent is: between 30 and 99 percent, between 30 and 95 percent, between 30 and 90 percent, or between 30 and 80 percent of the coextensive extent. In an embodiment, the continuous extent is: between 35 and 99 percent, between 35 and 95 percent, between 35 and 90 percent, or between 35 and 80 percent of the coextensive extent.

In an embodiment, the baffle structure comprises a baffle inlet configured to receive a portion of flow through the flameholder. In an embodiment, the baffle structure comprises a baffle outlet configured to discharge the portion of flow. In an embodiment, a size of the baffle inlet is greater than a size of the baffle outlet.

In an embodiment, the flameholder includes an exterior wall. In an embodiment, the baffle structure is at least partially coextensive with the exterior wall along the coextensive extent.

In an embodiment, the flameholder is configured to promote a formation of a wake-stabilised region within a flow of air downstream of the flameholder. In an embodiment, the external wall is a rear exterior wall which faces the wake-stabilised region. In an embodiment, the baffle structure is configured to direct flow through the flameholder toward the rear exterior wall.

In an embodiment, the flameholder is in the form of a unibody.

In an embodiment, the flameholder is a product of additive layer manufacturing.

According to a second aspect there is provided a reheat assembly for a gas turbine engine, the reheat assembly comprising:
a flameholder in accordance with the first aspect;
a jetpipe casing comprising:
a reheat core section configured to convey a core flow of air from a reheat core inlet to a reheat core outlet; and
a reheat bypass section configured to convey a bypass flow of air from a reheat bypass inlet to a reheat bypass outlet radially outward of the core section, the reheat core section and the reheat bypass section being radially separated at the reheat core inlet and the reheat bypass inlet by a support duct;
wherein the flameholder is mounted to the jetpipe casing and/or the support duct and is configured to receive a flow of air from the reheat bypass section.

In an embodiment, the flameholder is configured to promote a formation of a core flow wake-stabilised region within the core flow of air downstream of the flameholder. In an embodiment, the flameholder is a radially-extending flameholder within the reheat assembly (e.g., and the gas turbine engine).

According to a third aspect there is provided a gas turbine engine comprising:
a reheat assembly in accordance with the second aspect;
an engine core defining a core flow pathway; and
an outer casing which defines a bypass duct around the engine core; wherein:
the jetpipe casing is attached to the outer casing and the support duct is radially aligned an outlet of the engine core so that:
the reheat core inlet is aligned with an outlet of the core duct, and
the reheat bypass inlet is aligned with an outlet of the bypass duct;
the core flow pathway is configured to convey the core flow of air through the engine core to the reheat core inlet; and
the bypass duct is configured to convey the bypass flow of air to the reheat bypass inlet.

According to a fourth aspect there is provided an aircraft comprising a gas turbine engine in accordance with the third aspect.

### BRIEF DESCRIPTION OF THE DRAWINGS

Embodiments will now be described by way of example only with reference to the accompanying drawings, in which:

FIG. 1 is a top view of an aircraft;

FIG. 2 is a sectional side view of a gas turbine engine;

FIG. 3 is a sectional side view of a reheat assembly comprising a flameholder;

FIG. 4 is a rear view of the reheat assembly of FIG. 3;

FIG. 5 is a sectional side view of the flameholder shown by FIG. 3;

FIG. 6 is a further sectional view of the flameholder shown by FIG. 3; and

FIG. 7 is a cut-through perspective view of the flameholder of FIG. 3.

### DETAILED DESCRIPTION

### Aircraft

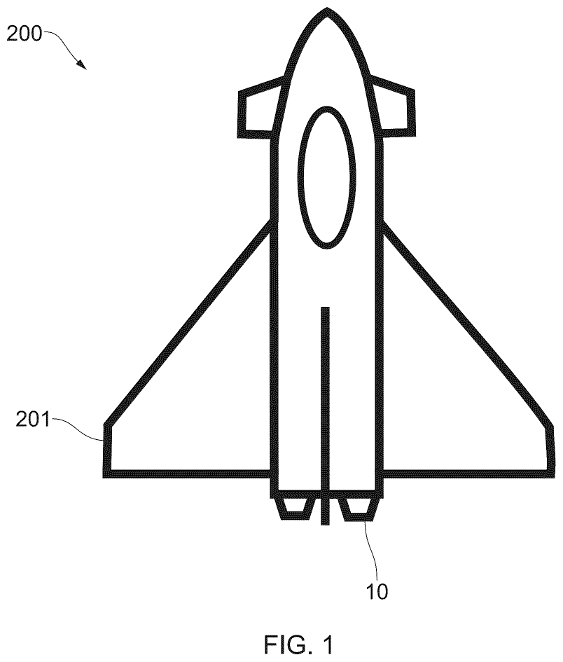

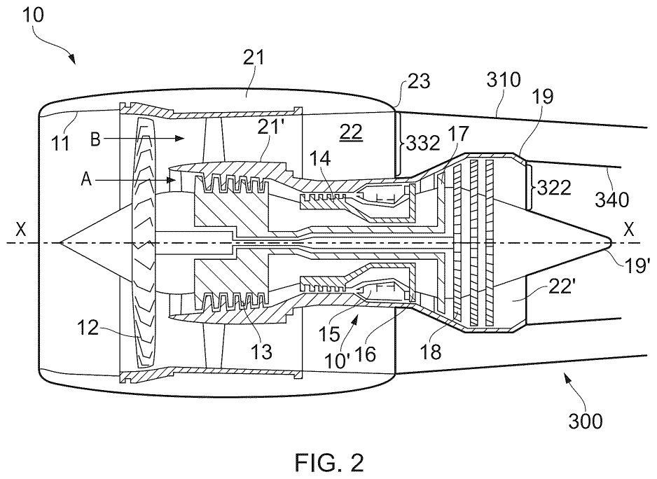

FIG. 1 shows a simplified and schematic view of an aircraft 200 comprising an airframe 201 and a gas turbine engine 10. The gas turbine engine 10 may be in accordance with the gas turbine engine 10 described below with reference to FIG. 2.

### Gas Turbine Engine

FIG. 2 shows a ducted fan gas turbine engine 10 having a principal and rotational axis X-X. The engine 10 generally comprises an air intake 11, a propulsive fan 12, and an engine core 10′. The engine core 10′ comprises, in axial flow series, an intermediate pressure compressor 13, a high-pressure compressor 14, combustion equipment 15, a high-pressure turbine 16, an intermediate pressure turbine 17, and a low-pressure turbine 18. An outer casing 21 generally surrounds the engine 10 and defines the intake 11, a bypass duct 22 and a bypass duct outlet 23. An inner casing 21′ defines a core duct 22′, in which the engine core 10′ is disposed, and further defines a core duct outlet 19 in which an exhaust cone 19′ is disposed.

During operation, air entering the intake 11 is accelerated by the fan 12 to produce two air flows: a core flow of air A into the engine core 10′ and a bypass flow of air B which passes through the bypass duct 22 to provide propulsive thrust. The intermediate pressure compressor 13 compresses the core flow of air A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the core duct outlet 19 to provide additional propulsive thrust. The resultant hot combustion products are exhausted through the core duct outlet 19. The high, intermediate and low-pressure turbines respectively drive the high and intermediate pressure compressors 14, 13 and the fan 12 by suitable interconnecting shafts.

### Reheat Assembly

The gas turbine engine 10 further comprises a reheat assembly 300. The reheat assembly 300 is generally configured to inject fuel into the core flow of air A downstream of the low-pressure turbine 18 and optionally to inject fuel into the bypass flow of air B for the purpose of combustion therein, causing the core flow of air A or the bypass flow of air B to be reheated, thereby providing additional propulsive thrust.

The reheat assembly 300 generally comprises a jetpipe casing 310 and a support duct 340. The support duct 340 extends axially from an upstream end of the jetpipe casing 310 (i.e., an end closest to the air intake 11), at least partially through the jetpipe casing 310 in a direction towards a downstream end of the jetpipe casing 310 (i.e., an end furthest from the air intake 11). The jetpipe casing 310 defines a reheat core section 320 configured to duct the core flow of air A from a reheat core inlet 322 to a reheat core outlet 324, and a reheat bypass section 330 configured to duct the bypass flow of air B from a reheat bypass inlet 332 to a reheat bypass outlet 334. The reheat bypass section 330 is annular and disposed radially outwardly from the reheat core section 320 such that the reheat bypass inlet 332 is disposed radially outward of the reheat core inlet 322, while the reheat bypass outlet 334 is also disposed radially outward of the reheat core outlet 324. The support duct 340 at least partially separates the reheat bypass section 330 from the reheat core section 320 at the upstream end of the jetpipe casing 310.

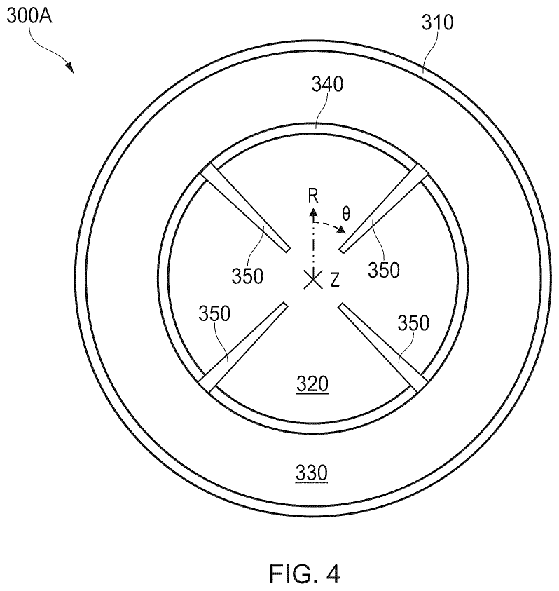

In this example, the gas turbine engine 10 comprises a plurality of reheat arrangements 350. Each reheat arrangement 350 is configured to enable the ignition of, and promote the stable formation of, a flame within the reheat assembly 300. In this example, the plurality of reheat arrangements 350 are circumferentially distributed around the jetpipe casing 310, as shown in FIG. 4 which shows a rear view of the reheat assembly 300. In other words, the plurality of reheat arrangements 350 are offset with respect to one another around a circumferential direction θ of the reheat assembly 300.

The plurality of reheat arrangements 350 are independently mounted to the jetpipe casing 310/support duct 340 so that they can be removed and replaced easily without requiring unnecessary removal and replacement of any other components. Although FIG. 4 shows a total of four reheat arrangements 350 offset with respect to one another around the circumferential direction θ of the reheat assembly 300, it will be appreciated that there may be any suitable number of reheat arrangements, which may be offset with respect to one another around the circumferential direction θ of the reheat assembly 300 in this way. In other examples, there may be only a single reheat arrangement 350.

The jetpipe casing 310 defines an afterburning region in the downstream end of the jetpipe casing 310 (downstream of the reheat arrangements 350) in which a core flow of air A and a bypass flow of air B from the reheat core section 320 and the reheat bypass section 330 respectively are able to mix, and in which fuel injected into the air streams is ignited to provide additional thrust.

The jetpipe casing 310 of the reheat assembly 300 is radially aligned with, and attached to the outer casing 21 such that the reheat bypass inlet 332 of the reheat assembly 300 is aligned with the bypass duct outlet 23. The support duct 340 of the reheat assembly 300 is radially aligned with, and attached to the inner casing 21′ such that the reheat core inlet 322 of the reheat assembly 300 is aligned with the core duct outlet 19.

Accordingly, the core duct 22′ of the gas turbine engine 10 is configured to convey the core flow of air A through the engine core 10′ to the reheat core inlet 322 and the bypass duct 22 of the gas turbine engine 10 is configured to convey the bypass flow of air B through the gas turbine engine 10 to the reheat bypass inlet 332, without passing through the engine core 10′.

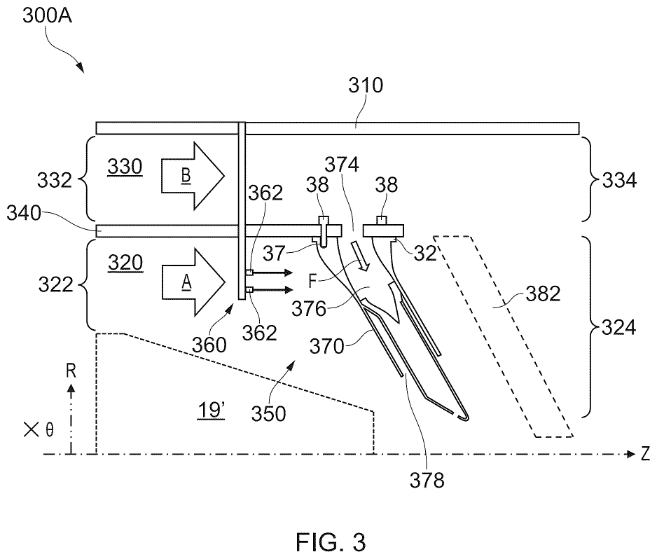

In addition, the reheat assembly 300 may have any suitable combination of features described below with reference to the example reheat assembly 300A shown in sectional side view by FIG. 3.

The reheat assembly 300A has an axial direction Z, a radial direction R and a circumferential direction θ. Because FIG. 3 is a sectional side view of the reheat assembly 300A, the circumferential direction θ is defined through the plane of the page, whereas the axial direction Z and the radial direction R are defined according to the direction of the corresponding coordinate arrows provided by FIG. 3. The reheat assembly 300A is configured such that, when the reheat assembly 300A is incorporated into a gas turbine engine, the axial direction Z of the reheat assembly 300A aligns with a principal and rotational axis of the gas turbine engine. The jetpipe casing 310 defines the axial direction Z, the radial direction R and the circumferential direction θ of the reheat assembly 300A.

As explained with reference to FIGS. 2 and 4, the reheat assembly 300A comprises a plurality of reheat arrangements 350, with only one being shown in the sectional side view of FIG. 3.

Each reheat arrangement 350 comprises a radially extending flameholder 370. The flameholder 370 is radially extending in that it extends (e.g., principally extends) along a direction having a component which is parallel to the radial direction R of the reheat assembly 300A. The flameholder is mounted to the support duct 340, as described in further detail below.

The radially extending flameholder 370 is configured to instigate and to maintain a relatively low-speed eddy within the core flow of air A to form a wake-stabilised region 382 (e.g., a core flow wake-stabilised region 382) located downstream of the flameholder 370. The relatively low-speed eddy in the wake-stabilised region 382 enables a flame to be stably formed (e.g., “held”) therein.

The reheat arrangement 350 further comprises a plurality of fuel injection ports including a plurality of core fuel injection ports 362 (only two are shown for simplicity). Each core fuel injection port 362 is configured to discharge a flow of fuel into the reheat core section 320 for mixing with the core flow of air A and thus creating a fuel-air mixture.

Each core fuel injection port 362 is located upstream of the wake-stabilised region 382. In this example, the plurality of fuel injection ports 362 are disposed on a separate fuel injection pipe which is located upstream of the flameholder 370 and is separately mounted to the jetpipe casing 310. Further, in this example, the core fuel injection ports 362 are located in the same circumferential plane defined by the axial direction Z and the radial direction R as the flameholder 370, such that the core fuel injection ports 362 are substantially circumferentially aligned with the flameholder 370. In some examples, there may be only a single core fuel injection port 362.

In this example, the plurality of fuel injection ports 362 are offset with respect to one another along a radial direction R of the jetpipe casing 310. This ensures that each fuel injection port 362 injects fuel into the jetpipe casing 310 at a different radial location.

The provision of a plurality of core fuel injection ports offset with respect to each other along the radial direction R of the jetpipe casing 310 enables better control of thrust produced by igniting the fuel in the core flow of air A. Similarly, the provision of the plurality of bypass fuel injection ports offset with respect to each other along the radial direction R of the jetpipe casing 310 enables further improved control of thrust produced by igniting the fuel injected into the bypass flow of air B.

In this example, each of the plurality of fuel injection ports 362 is configured to discharge the respective flow of fuel in a direction within the plane perpendicular to the axial direction Z of the jetpipe casing 310. In other examples, the discharge of fuel may not be fully perpendicular to the axial direction, but may be in a direction having a component perpendicular to the axial direction Z of the jetpipe casing 310 (i.e., not parallel to the axial direction Z). Discharging fuel in such a direction improves the mixing of the fuel in the air flow in which it is discharged, by increasing atomisation of the fuel (i.e., creating smaller droplets of fuel) due to the increased difference in relative velocity between the fuel being discharged and the core flow of air A and the bypass flow of air B respectively (i.e., due to the increase in shear stress between the fuel and the air, which shears the fuel into smaller droplets). In yet further examples, the discharge of fuel may be in a direction parallel to the axial direction Z of the jetpipe casing 310.

The reheat arrangement 350 further comprises a fuel supply system 360 configured to supply the flow of fuel to each of the fuel injection ports 362. The fuel supply system 360 is usable to control fuel discharge from the fuel injection ports 362 so as to vary the amount of additional thrust provided by the reheat assembly 300A and to vary the likelihood of ignition of the fuel. For example, if only limited additional thrust is needed, fuel discharge can be staged by leaving only a single radially innermost core fuel injection port 362 open. If a maximum amount of additional thrust is required, the control valves may be controlled to open fully for all of the fuel injection ports 362. The fuel discharge can also be staged circumferentially in each flameholder 370, for example by discharging fuel from only a single flameholder 370 when limited additional thrust is needed, compared to discharging fuel from all of the flameholders 370 around the circumference.

The reheat assembly 300A may be provided with a pilot (not shown) configured to cause ignition of the fuel within the wake-stabilised region 382 and thus create a flame therein. In other examples, the fuel may auto-ignite within the wake-stabilised region 382 due to the high temperatures of the air therein without the need for a pilot to be provided.

In this example, the at least one core fuel injection port 362 is separate from the flameholder 370 and is located upstream of the flameholder 370 such that a suitable distance between the fuel injection ports 362 and the radially extending flameholder 370 may be selected to select a suitable distance between the fuel injection ports 362 and the wake-stabilised region 382 along the axial direction Z. The distance between the fuel injection ports 362 and the radially extending flameholder 370 along the axial direction Z may be selected so as to ensure that the fuel within the core flow of air A does not reach the autoignition temperature prior to entering the wake stabilised region 382.

### Flameholders

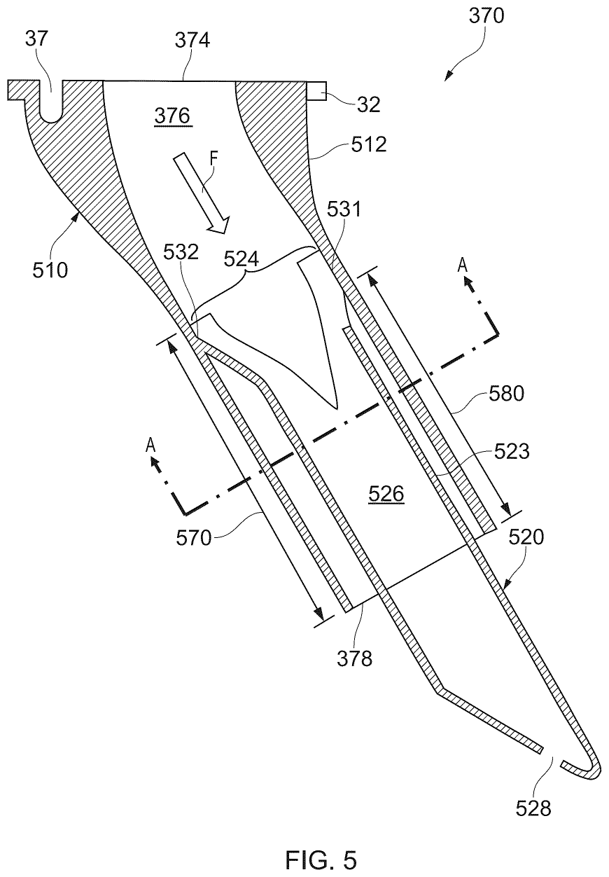

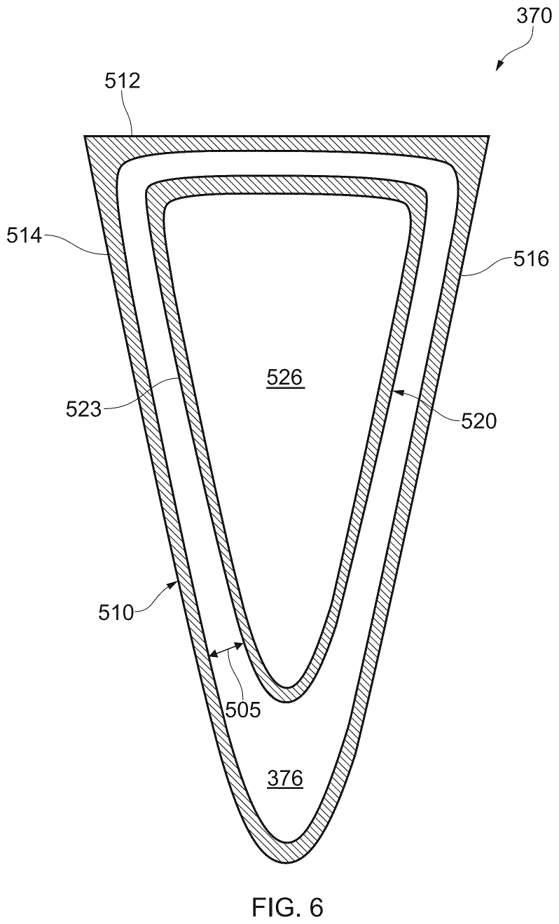

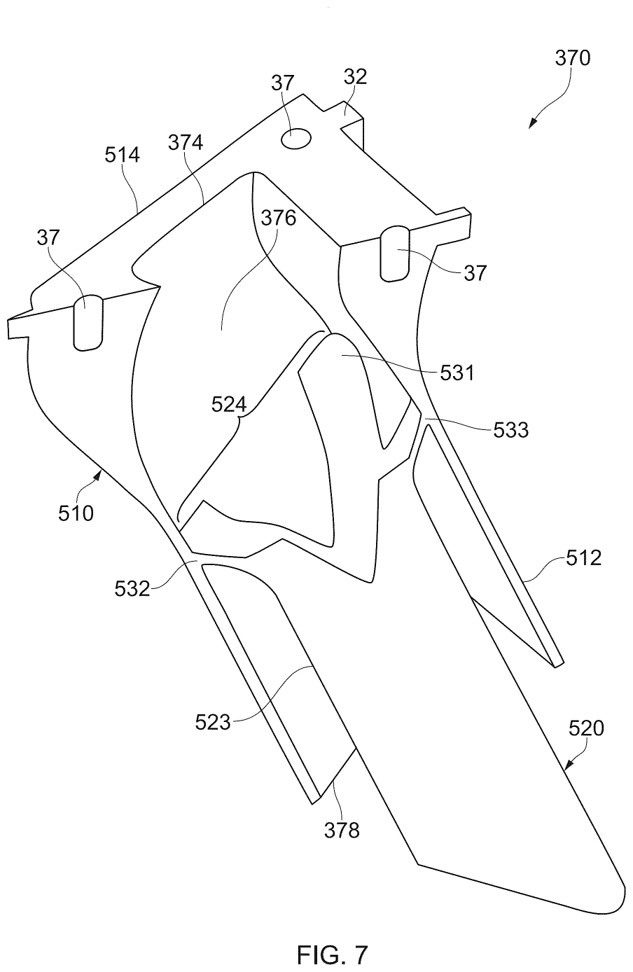

FIG. 5 shows a sectional side view of the flameholder shown by FIG. 3 in isolation (e.g., separate from the reheat assembly 300A). FIG. 6 is a cross-sectional view of the flameholder shown by FIG. 3 as indicated by A-A on FIG. 5. FIG. 7 is a cut-through perspective view of the flameholder of FIG. 3. The following description is provided with particular reference to FIGS. 5 to 7.

The flameholder 370 is in the form of a unibody. In this example, the flameholder is produced by an additive layer manufacturing process such as powder bed fusion or selective laser sintering, but in other examples may be formed by other processes (e.g., hot isostatic pressing). The flameholder 370 comprises a flange portion 32, a main structure 510, and a baffle structure 520. The flange portion 32 is configured to facilitate attachment of the flameholder 370 to the support duct 340. Accordingly, the flange portion 32 has a shape which complements a shape of a local area of the support duct 340 to which the flameholder 370 is attached. The flange portion also defines an inlet aperture 374 configured to receive a cooling flow of air from the reheat bypass section 320. The flameholder 370 further defines an outlet aperture 378 which opens into the reheat core section 320 at a radially inward end of the flameholder 370.

The main structure 510 defines an internal flow passageway 376 extending from the inlet aperture 374 to the outlet aperture 378. The internal flow passageway 376 is configured to convey the cooling flow of air from the inlet aperture 374 through an interior of the flameholder to the outlet aperture 378 for heat exchange between the flameholder 370 and the cooling flow of air. Once the cooling flow of air reaches the outlet aperture 378, it is discharged into the reheat core section 320. In this way, the internal flow passageway 376 defines a flow direction F for the cooling flow of air through the flameholder 370.

The main structure 510 comprises a rear exterior wall 512. The rear exterior wall 512 faces the wake-stabilised region 382 that the flameholder 370 is configured to promote the formation of, and which is generally aft of the flameholder as installed. As a result, the rear exterior wall 512 is subject to relatively strong heating (e.g., radiative heating) by the flame which is held within the wake-stabilised region 382 during operation of the reheat assembly 300A. The main structure 510 includes a pair of side walls 514, 516 which are joined at an apex and do not face the wake-stabilised region 382. Correspondingly, the rear exterior wall 512 faces away from the pair of side walls 514, 516. The pair of side walls 514, 516 are also joined with the rear exterior wall 512 at respective apices. The flameholder 370 has a generally triangular shape in the plane shown by FIG. 6.

As best shown by FIG. 3, the flameholder 370 is inclined within the reheat core section 320 with respect to the core flow of air A. Namely, a part of a leading edge of the flameholder 370 adjacent to the inlet aperture 374 is more proximal to the reheat core inlet 322 than a part of the leading edge of the flameholder 370 adjacent to the outlet aperture 378. Likewise, a part of a trailing edge of the flameholder 370 adjacent to the inlet aperture 374 is more proximal to the reheat core inlet 322 than a part of the trailing edge of the flameholder 370 adjacent to the outlet aperture 378. The flameholder extends radially inwardly and aft from the support duct 340.

Each flange portion 32 defines a plurality of holes 37 therein. A fastener 38 extends into each hole 37 through the support duct 340 and thereby mounts (e.g., attaches) the flameholder 370 to the support duct 340. The flameholder 370 is therefore mounted to the support duct 340 by a plurality of fasteners 38, each of which extends through the support duct 340 into a respective hole 37 to mount the flameholder 370 to the support duct 340. The fasteners 38 each include a male threaded feature which enables the fastener 38 to threadedly engage the flameholder 370. In the example of FIG. 3, the fasteners 38 are bolts. Although the fasteners 38 of FIG. 3 are shown as having heads which extend above the support duct 340 and into the reheat bypass duct 330, it may be that the support duct 340 comprises a plurality of recesses, with each recess being configured to receive the heads of the fastener 38 (which may be a countersunk heads) such that no part of the fasteners 38 extend into the reheat bypass duct 300 when fully assembled.

The baffle structure 520 is disposed within the main structure 510. Specifically, the baffle structure 520 is located within the internal flow passageway 376 and is configured to preferentially direct the cooling flow of air through the flameholder 370 within the internal flow passageway 376 toward the rear exterior wall 512. In this way, the presence of the baffle structure 520 within the internal flow passageway 376 promotes effective cooling of the rear exterior wall 512 by the cooling flow of air. The preferential direction of the cooling flow of air may result in a major portion of the cooling flow (e.g. by mass flow rate) flowing between the rear of the baffle structure 520 and the rear exterior wall 512, and/or may promote an elevated flow rate at that location relative to other paths through the flameholder 370 (e.g., a path between the apex of the side walls and the front side of the baffle structure 520) to promote heat transfer.

In this example, the baffle structure 520 extends outside of and below the outlet aperture 378 (e.g., closer to the axial direction/rotational axis X-X) such that a bottommost portion of the baffle structure 520 is exposed to the core flow of air A in use. In other examples, the baffle structure 520 may not extend outside of the outlet aperture 378 such that the baffle structure 520 is not exposed to the core flow of air A in use.

The baffle structure 520 is hollow. That is, the baffle structure comprises a baffle inlet 524 and a baffle outlet 528, each of which open into a void 526 defined by the baffle structure. The baffle inlet 524 is configured to receive a portion of the cooling flow of air through the flameholder while the baffle outlet 528 is configured to discharge the portion of the cooling flow of air. A size (e.g., a cross-sectional size, such as a cross-sectional size normal to the flow direction F) of the baffle inlet 524 is greater than a size (e.g., a correspondingly measured size) of the baffle outlet 528. The baffle outlet 528 therefore presents a relative obstruction to the portion of the cooling flow of air through the baffle structure 376. As a result, a static pressure inside the void 526 defined by the baffle structure 520 is greater than a static pressure within the internal flow passageway 376 outside the void 526. This static pressure differential may cause or correspond to the cooling flow of air being preferentially directed around the baffle structure 520 and thus, at least in part, toward the rear exterior wall 512.

The baffle structure 520 is suspended within the main structure 510 at a plurality of mounting locations 531, 532, 533 (as best shown in FIG. 7). The baffle structure 520 has a detached portion 523 spaced apart (e.g., offset) from the mounting locations 531, 532, 533 along the flow direction F. The baffle structure 520 is coextensive with the main structure 510 in the flow direction F along a coextensive extent 570. Accordingly, the baffle structure 520 is also partially coextensive with the rear exterior wall 512 along the coextensive extent 570 (e.g., along a proper subset of the coextensive extent 570).

The detached portion 523 is integrally formed with the main structure 510. As best shown by FIG. 6, the detachment between the main structure 510 and the detached portion CPT results in the formation of a gap 505 therebetween around a perimeter of the flameholder 370. The gap 505 separates the baffle structure 520 from the main structure 510 in a separation direction which is perpendicular to the flow direction F.

The detached portion 523 is detached from the main structure 510 along a continuous extent 580, with the continuous extent 580 being a substantial fraction of the coextensive extent 570. The continuous extent 580 is “continuous” in that the detached portion 523 does not reattach with the main structure 510 at any point along the continuous extent 580. In the example of FIGS. 5 to 7, the substantial fraction may be approximately 80 percent, and that the continuous extent 580 may be approximately (e.g., no greater than) 80 percent of the coextensive extent 570.

In some examples, the continuous extent 580 may be relatively smaller (e.g., be a smaller fraction with respect to the coextensive extent 570). Namely, the continuous extent 580 may be at least 10 percent, at least 15 percent, at least 20 percent, at least 25 percent, at least 30 percent or at least 35 percent of the coextensive extent 570.

In other examples, the continuous extent 580 may be relatively larger (e.g., be a larger fraction with respect to the coextensive extent 570). In other examples, the continuous extent 580 is up to (e.g., no greater than) 90 percent, 95 percent or 99 percent of the coextensive extent 570, such that the detached portion 523 joins (e.g., merges) with main structure 510 within the coextensive extent 570 at the mounting locations 531, 532, 533.

The continuous extent 580 may be: between 10 and 99 percent, between 10 and 95 percent, between 10 and 90 percent, or between 10 and 80 percent of the coextensive extent 570. The continuous extent 580 may be: between 15 and 99 percent, between 15 and 95 percent, between 15 and 90 percent, or between 15 and 80 percent of the coextensive extent 570. The continuous extent 580 may be: between 20 and 99 percent, between 20 and 95 percent, between 20 and 90 percent, or between 20 and 80 percent of the coextensive extent 570. The continuous extent 580 may be: between 25 and 99 percent, between 25 and 95 percent, between 25 and 90 percent, or between 25 and 80 percent of the coextensive extent 570. The continuous extent 580 may be: between 30 and 99 percent, between 30 and 95 percent, between 30 and 90 percent, or between 30 and 80 percent of the coextensive extent 570. The continuous extent 580 may be: between 35 and 99 percent, between 35 and 95 percent, between 35 and 90 percent, or between 35 and 80 percent of the coextensive extent 570.

As discussed above, by virtue of facing the wake-stabilised region 382, the rear exterior wall 512 is subject to relatively strong heating (e.g., radiative heating) during operation of the reheat assembly 300A as a consequence of the fuel-air mixture being combusted within the flame therein. Resultingly, a thermal temperature differential between the rear exterior wall 512/main structure 510 and the baffle structure 520 may rapidly develop as the reheat assembly 300A begins to operate (e.g., creates and maintains a flame within the wake-stabilised region 382) and thus the gas turbine engine 10 transitions from a dry operating state (i.e., without reheating/afterburning) into a wet operating state (i.e., with reheating/afterburning). The detached portion 523 being detached from the main structure 510 along the continuous extent 580 allows the rear exterior wall 512/main structure 510 to thermally expand independently of the detached portion 523 of the baffle structure 520 within the continuous extent 580. This is associated with reduced thermal fight/internal stresses within the flameholder 370, which reduces a likelihood of failure of the flameholder 370 over time.

### Other

Various examples have been described, each of which comprise one or more combinations of features. It will be appreciated by those skilled in the art that, except where clearly mutually exclusive, any of the features may be employed separately or in combination with any other features and the invention extends to and includes all combinations and sub-combinations of one or more features described herein. The present disclosure is also relevant for land, aviation and marine applications in both civil and military contexts.

1. A flameholder for a reheat assembly of a gas turbine engine, wherein:
the flameholder comprises a main structure and a baffle structure;
the main structure at least partially defines a flow direction for flow through the flameholder;
the baffle structure is suspended within the main structure at one or more mounting locations;
the baffle structure is coextensive with the main structure in the flow direction along a coextensive extent; and
the baffle structure has a detached portion spaced apart from the one or more mounting locations, the detached portion being detached from the main structure over a continuous extent which is at least 10 percent of the coextensive extent.

2. The flameholder of claim 1, wherein the continuous extent is at least 20 percent of the coextensive extent.

3. The flameholder of claim 1, wherein the continuous extent is at least 30 percent of the coextensive extent.

4. The flameholder of claim 1, wherein the continuous extent is no greater than 90 percent of the coextensive extent.

5. The flameholder of claim 1, wherein the continuous extent is no greater than 80 percent of the coextensive extent.

6. The flameholder of claim 1, wherein the baffle structure comprises a baffle inlet configured to receive a portion of flow through the flameholder.

7. The flameholder of claim 1, wherein the flameholder includes an exterior wall.

8. The flameholder of claim 7, wherein the baffle structure is at least partially coextensive with the exterior wall along the coextensive extent.

9. The flameholder of claim 7, wherein:
the flameholder is configured to promote a formation of a wake-stabilised region within a flow of air downstream of the flameholder; and
the external wall is a rear exterior wall which faces the wake-stabilised region.

10. The flameholder of claim 9, wherein the baffle structure is configured to direct flow through the flameholder toward the rear exterior wall.

11. The flameholder of claim 1, wherein the flameholder is in the form of a unibody.

12. The flameholder of claim 1, wherein the flameholder is a product of additive layer manufacturing.

13. A reheat assembly for a gas turbine engine, the reheat assembly comprising:
the flameholder of claim 1:
a jetpipe casing comprising:
a reheat core section configured to convey a core flow of air from a reheat core inlet to a reheat core outlet; and
a reheat bypass section configured to convey a bypass flow of air from a reheat bypass inlet to a reheat bypass outlet radially outward of the core section, the reheat core section and the reheat bypass section being radially separated at the reheat core inlet and the reheat bypass inlet by a support duct;
wherein the flameholder is mounted to the jetpipe casing and/or the support duct and is configured to receive a flow of air from the reheat bypass section.

14. A gas turbine engine comprising:
the reheat assembly of claim 13;
an engine core defining a core flow pathway; and
an outer casing which defines a bypass duct around the engine core; wherein:
the jetpipe casing is attached to the outer casing and the support duct is radially aligned an outlet of the engine core so that:
the reheat core inlet is aligned with an outlet of the core duct, and
the reheat bypass inlet is aligned with an outlet of the bypass duct;
the core flow pathway is configured to convey the core flow of air through the engine core to the reheat core inlet; and
the bypass duct is configured to convey the bypass flow of air to the reheat bypass inlet.

15. An aircraft comprising the gas turbine engine of claim 14.
